(19) United States
(12) Patent Application Publication
(10) Pub. No.: US 2020/0184382 A1
(43) Pub. Date: Jun. 11, 2020

(54) COMBINING OPTIMIZATION METHODS FOR MODEL SEARCH IN AUTOMATED MACHINE LEARNING

(71) Applicant: Deep Learn, Inc., Santa Cruz, CA (US)

(72) Inventors: Alexander Fishkov, St. Petersburg (RU); Vladislav Khizanov, Kiev (UA)

(21) Appl. No.: 16/696,876

(22) Filed: Nov. 26, 2019

Related U.S. Application Data
(60) Provisional application No. 62/778,045, filed on Dec. 11, 2018.

(51) Int. Cl. G06N 20/20; G06N 5/04

(52) U.S. Cl. CPC G06N 20/20; G06N 5/04

(57) ABSTRACT

Optimization process for automated machine learning with a combination of different optimizers. In an embodiment, optimization is performed by, for each of a plurality of machine-learning algorithms, executing a Bayesian optimization algorithm to produce a plurality of trialed models, wherein each of the plurality of trialed models is associated with the machine-learning algorithm and a set of hyperparameters. A subset of best-performing machine-learning algorithms is selected, and, for each machine-learning algorithm in the subset, a best-performing model from the plurality of trialed models associated with that machine-learning algorithm is selected, and a local search algorithm is executed starting from the set of hyperparameters associated with the selected best-performing model to identify an improved model that has better performance than the selected best-performing model.

### CROSS-REFERENCE TO RELATED APPLICATIONS

This application claims priority to U.S. Provisional Patent App. No. 62/778,045, filed on Dec. 11, 2018, which is hereby incorporated herein by reference as if set forth in full.

### BACKGROUND

### Field of the Invention

The embodiments described herein are generally directed to automated machine learning, and, more particularly, to a method of combining optimization methods for selecting one or more optimal models for automated machine learning.

### Description of the Related Art

Automated machine learning (AutoML) is one of the most robust areas of innovation in applied machine learning. AutoML tools try many different machine-learning algorithms and many values for those algorithms' hyperparameters (i.e., options for the algorithms), in an attempt to find the model with the highest possible predictive accuracy. Even experienced data scientists may require weeks of effort to identify the optimal model.

New AutoML tools are rapidly appearing, from the likes of Google™ and Microsoft™, as well as new startups. The activity in this space promises to make machine learning accessible to the masses, without the need for trained data scientists. However, most AutoML tools attempt to use a single optimization of trying all possible algorithms and hyperparameters to find a good predictive model.

### SUMMARY

Accordingly, systems, methods, and non-transitory computer-readable media are disclosed for a method that combines multiple optimization methods to reduce the chance of suboptimal models being selected. For example, a platform may be provided that comprises a service that utilizes a combination of optimizers (e.g., Bayesian optimization in combination with local searches) to find optimal models to be used in automated machine learning.

In an embodiment, a method is disclosed that comprises using at least one hardware processor to: receive a plurality of machine-learning algorithms; and, perform optimization by, for one or more iterations, for each of the plurality of machine-learning algorithms, executing a Bayesian optimization algorithm to produce a plurality of trialed models, wherein each of the plurality of trialed models is associated with the machine-learning algorithm and a set of hyperparameters, selecting a subset of best-performing ones of the plurality of machine-learning algorithms, and, for each machine-learning algorithm in the subset of best-performing machine-learning algorithms, selecting a best-performing model from the plurality of trialed models associated with the machine-learning algorithm, and executing a local search algorithm starting from the set of hyperparameters associated with the selected best-performing model to identify an improved model that has better performance than the selected best-performing model. The method may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram that illustrates an example infrastructure, in which one or more of the processes described herein, may be implemented, according to an embodiment;

FIG. 2 is a block diagram that illustrates an example processing system, by which one or more of the processed described herein, may be executed, according to an embodiment;

FIG. 3 is a flowchart that illustrates a process for automated machine-learning management, according to an embodiment; and

FIG. 4 is a flowchart that illustrates a process for combining optimization methods, according to an embodiment.

### DETAILED DESCRIPTION

In an embodiment, systems, methods, and non-transitory computer-readable media are disclosed for an optimization process using a combination of optimization methods. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

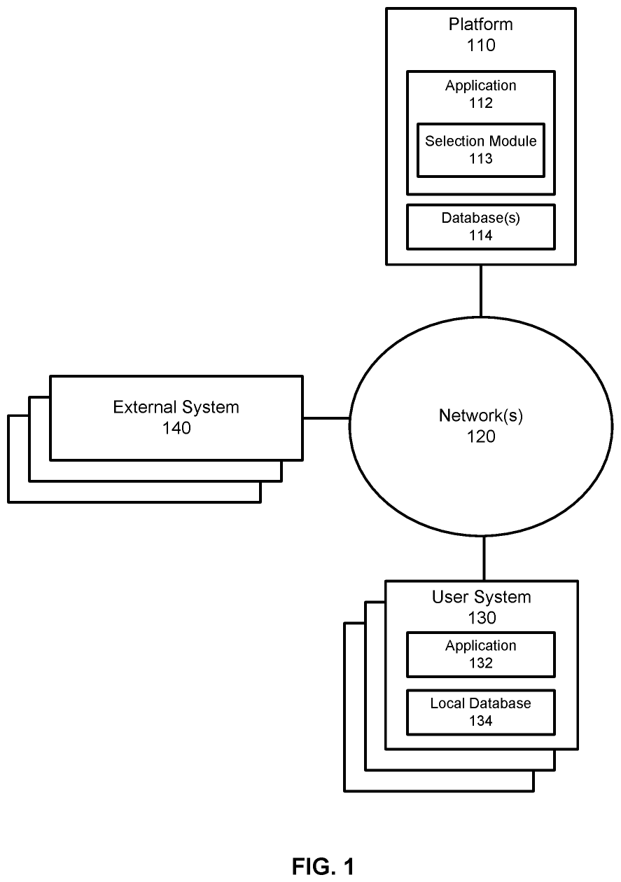

FIG. 1 illustrates an example infrastructure for selecting algorithms for automated machine learning, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application is a browser application, which simply requests, receives, and renders webpages at user system(s) 130, while the server application on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the functions, processes, or methods of the application described herein.

In an embodiment, the application implements a selection module 113 for selecting an appropriate machine-learning algorithm. Selection module 113 may be offered as part of a larger service implemented by the application. For example, in an embodiment, the application implements an automated machine-learning service which enables a user to manage the user's machine-learning algorithms, for example, within the user's cloud services. As part of this management, the application may enable a user to select one or more algorithms, optimize hyperparameters for the algorithm(s), and deploy the selected algorithm(s) with the optimized hyperparameters to the user's cloud services. The combination of the algorithm(s) and associated hyperparameters will be referred to herein as a “model.”

Selection module 113 is able to offer a plurality of available algorithms for selection. These available algorithms may comprise basic regression algorithms, including, without limitation, logistic regression, linear regression, polynomial regression, k-nearest neighbor, and/or random forest algorithms. The available algorithms may also comprise more complex algorithms, such as deep-learning neural networks. In addition, selection module 113 may enable users to set appropriate hyperparameters for the training process, and allows users to combine a plurality of algorithms into an ensemble algorithm.

1.2. Example Processing Device

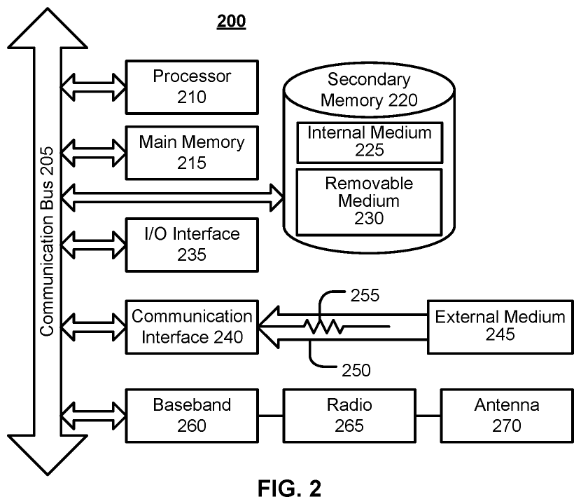

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may also be used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

2. Process Overview

Embodiments of processes using a combination of optimization methods will now be described in detail. It should be understood that the described processes may be embodied in one or more software modules that are executed by one or more hardware processors (e.g., processor 210), e.g., as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described process may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

2.1. Automated Machine-Learning Management

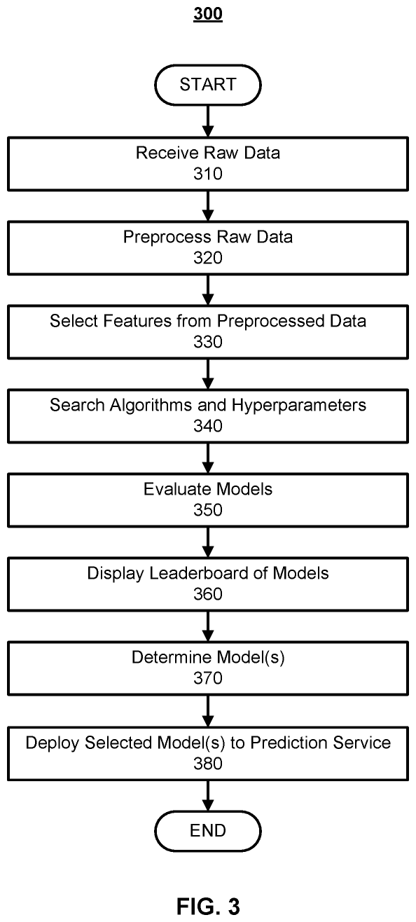

FIG. 3 is a flowchart that illustrates a process 300 for automated machine-learning management, according to an embodiment. While process 300 is illustrated with a certain arrangement and ordering of steps, process 300 may be implemented with fewer, more, or different steps and a different arrangement and/or ordering of steps. In addition, while process 300 is illustrated as a linear process, certain steps may be performed non-linearly (e.g., in parallel) and/or within iterative loops. Process 300 may be implemented by the disclosed application, and, in an embodiment, specifically by server application 112.

In step 310, the application receives raw data. For example, the raw data may be received from a user via a graphical user interface. Specifically, the user may utilize one or more inputs to upload the raw data (e.g., by selecting a file from a file system of the user's user system 130) or otherwise retrieve the raw data (e.g., from database(s) 114, from an external system 140, etc.). The raw data may be received in various formats, including in an electronic document, such as a file of comma-separated values (CSV), a spreadsheet file (e.g., Excel™), and/or the like.

In step 320, the application preprocesses the raw data received in step 310. For example, the raw data may be parsed into a dataset to be used in subsequent steps. Using a CSV file as an example, a data structure may be created for each row of comma-separated values, and each row-specific data structure may comprise field-specific data structures representing each of the comma-separated values in that row. It should be understood that each row should include the same set of fields, although values may not be provided for all fields in a given row. Field names may be included in a header row, which can also be parsed in step 310. All of the row-specific data structures and the field names may be comprised in an overarching data structure representing the entire dataset. Alternatively, the raw data may be maintained in the native file format and re-parsed every time it is needed. In addition to parsing the data, other preprocessing may be performed, such as validating the raw data (e.g., ensuring that it is properly formatted, identifying issues with field values, etc.) and/or the like.

In step 330, the application determines the features to be used by the machine-learning algorithms and/or the target feature to be predicted by the machine-learning algorithms. For example, the application may generate one or more screens of the graphical user interface to include a list of all of the field names identified in the raw data. Each field name may be associated with one or more inputs, including, without limitation, inputs for selecting a data type (e.g., integer, categorical, etc.) to be used for the field, specifying a filter to be used for the values in the field, specifying a default value to be used for missing values in the field, selecting the field as a feature to be used in each machine-learning algorithm, selecting the field as a target feature to be predicted by each machine-learning algorithm, viewing actual values of the field in the dataset, and/or the like. Each field name may also be associated with other information to aid a user in the feature selection process, including, without limitation, a feature correlation, the number of unique values for the field, a range of values for the field, a number of missing values for the field, and/or the like. Using the inputs in the graphical user interface, a user may select one or more target features to be predicted by the machine-learning algorithm and one or more features (e.g., potentially all of the features) to be used by the machine-learning algorithm to predict the target feature(s). The screen(s) of the graphical user interface may also comprise one or more inputs to select a type of machine-learning algorithm to be used (e.g., regression or classification) and initiate the automated evaluation of a plurality of available machine-learning algorithms of the selected type.

In step 340, once the evaluation has been initiated, the application selects at least a subset of available machine-learning algorithms based on one or more user-specified inputs (e.g., the selection of regression or classification as the type of machine-learning algorithm to be used). For each selected machine-learning algorithm, the application may also select a set of one or more hyperparameters to be used when evaluating the machine-learning algorithm.

In step 350, each model is evaluated. Each model comprises at least one machine-learning algorithm and potentially a set of one or more hyperparameters. It should be understood that two models may comprise the same machine-learning algorithm but with different sets of hyperparameters. In an embodiment, the evaluation uses k-fold cross-validation. In k-fold cross-validation, the dataset is partitioned into k equally sized subsets, and then, over k iterations, a single subset is selected for testing the model, while the remaining k−1 subsets are used for training the model, such that, across all k iterations, each subset is used once for testing the model. The application may initiate a plurality of worker threads to evaluate a plurality of models in parallel. In addition, the application may generate an evaluation score (e.g., an accuracy score within a range from zero to one) for each model. During step 340, the application may also represent its progress (e.g., status, percentage complete, etc.) and/or provide statistics about the evaluation (e.g., number of worker threads used, CPU usage for each worker thread, memory usage for each worker thread, etc.) within the graphical user interface.

In step 360, the application provides a “leaderboard” of at least a topmost subset of the evaluated models in the graphical user interface. Specifically, the evaluated models may listed in order of their respective evaluation scores, with the highest scoring model at the top and the lowest scoring model at the bottom. The list may comprise a description of the model (e.g., an identification of the machine-learning algorithm and the hyperparameters used for the model) and the evaluation score. In addition, the list may comprise other statistics for the model, such as the number of features used, the number of k-folds used, and/or the like. The list may also comprise inputs for selecting and/or exporting each model (e.g., for deployment on the user's prediction service).

In step 370, the application determines the model(s) to be used. For example, the user may select one or more models from the leaderboard using one or more associated inputs in the graphical user interface. The user may select a single model or may select a plurality of models (e.g., comprising an ensemble of machine-learning algorithms). Once at least one model is selected, the graphical user interface may enable one or more inputs for deploying the selected model(s) to the user's prediction service.

In step 380, the application deploys the selected model(s) to the user's prediction service (e.g., in response to the user's selection of a deployment input). The user's prediction service may be a cloud service that the user has registered with the user's account on platform 110. For example, the user may assign a role within the user's cloud service to server application 112, and, via one or more account settings screen of the graphical user interface, provide server application 112 with the credentials for accessing the user's cloud service according to the assigned role. Thus, server application 112 may access the user's cloud service to directly deploy the selected model(s) on the user's cloud service.

2.2. Optimizer

In an embodiment, selection module 113 facilitates optimal model selection using a combination of optimization methods. For example, the combination of optimization methods may include Bayesian optimization in combination with local searches (e.g., Nelder-Mead, Lipschitz optimization (LIPO), Hill Climbing, Gradient Descent, etc.) to identify the optimal set of hyperparameters for one or more machine-learning algorithms to build a set of models for selection (e.g., to be deployed on a user's prediction service). This combination of optimization methods can prevent the optimization process from getting stuck in local optima. While this problem could be alternatively addressed using random restarts (e.g., start a single optimization method multiple times from scratch with different initial points), such a process can take a lot of time without any guarantee of improvement.

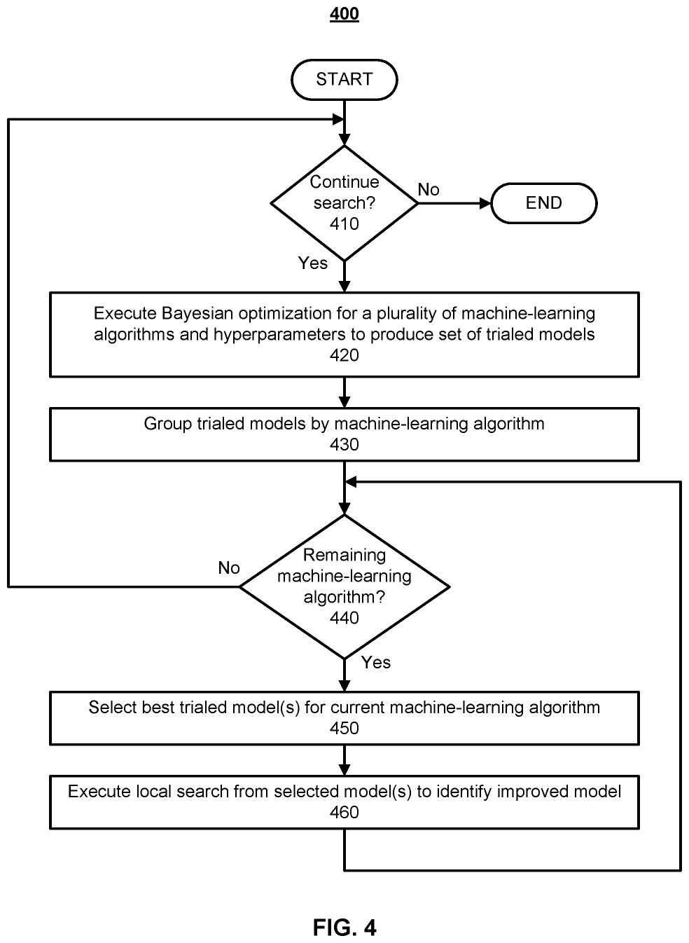

FIG. 4 is a flowchart that illustrates a process 400 for combining optimization methods, according to an embodiment. While process 400 is illustrated with a certain arrangement and ordering of steps, process 400 may be implemented with fewer, more, or different steps and a different arrangement and/or ordering of steps. As will be apparent, process 400 may include at least a portion of step 340. Process 400 may be implemented by the disclosed application, and, in an embodiment, specifically by selection module 113 of server application 112. For example, process 400 could be implemented by a trial-based optimization service of selection module 113 that searches for model(s) (i.e., each comprising a machine-learning algorithm and one or more hyperparameters) to accurately predict a target feature (e.g., selected in step 330) based on input features (e.g., also selected in step 330), using known data (e.g., received and preprocessed in steps 310 and 320)

In step 410, the service determines whether or not to continue searching for models. In an embodiment, the service may continue searching for models until stopped (e.g., by a user operation) and/or until one or more criteria are met (e.g., a predetermined amount of time has passed since the search began, a predetermined number of models have been found having an evaluation score exceeding a predetermined threshold value, etc.). If the service determines to continue the search (i.e., “Yes” in step 410), the service proceeds to the subsequent steps. Otherwise, if the service determines not to continue the search (i.e., “No” in step 410), the service ends the search.

In step 420, the service executes Bayesian optimization for a plurality of machine-learning algorithms and hyperparameters to produce a set of trialed models. Specifically, the service may receive or select a plurality of different machine-learning algorithms to be trialed. For each of the plurality of machine-learning algorithms, the service utilizes a Bayesian optimization algorithm (e.g., HyperOpt™) to identify sets of one or more hyperparameters for the machine-learning algorithm.

Bayesian optimization balances exploration and exploitation to search an entire domain (e.g., range, set, etc.) of possible hyperparameters. For example, the service attempts to minimize a validation error with respect to the known data, by executing a plurality of trials for a given machine-learning algorithm using different sets of hyperparameters. The validation error is represented by an objective function. While the sets of hyperparameters to be tested in each trial could be randomly selected, Bayesian optimization represents an improvement over a random search by selecting sets of hyperparameters that, based on the results of past trials, likely represent an improvement in the validation error. In other words, compared to a random search, Bayesian optimization spends slightly more computational effort to select the next set of hyperparameters to be trialed, in order to reduce the number of times that the much more computationally expensive objective function must be executed. The Bayesian optimization may be performed until there is low variability in suggested trials for each machine-learning algorithm, for a predetermined number of trials for each machine-learning algorithm, for a predetermined number of trials across all machine-learning algorithms, for a predetermined amount of time, and/or the like.

The result of the Bayesian optimization will be a plurality of models, each representing a separate trial of one of the plurality of machine-learning algorithms with a set of hyperparameters, and each associated with a validation error computed from the objective function. Thus, each of the plurality of machine-learning algorithms will be represented in a subset of the plurality of trialed models, but in combination with a variety of different hyperparameters.

In step 430, the service groups trialed models, produced in step 420, by the machine-learning algorithm used in the models, and selects one or more of the better performing machine-learning algorithms, including the best performing machine-learning algorithm (e.g., the two or three highest performing machine-learning algorithms). As mentioned above, each of the plurality of machine-learning algorithms, searched in step 420, will be associated with a group of trialed models. The plurality of machine-learning algorithms may be ranked, with respect to each other, using cross-validation. The service then selects a predefined number (e.g., one, two, three, five, ten, etc.) of the top ranked machine-learning algorithms.

In step 440, the service determines whether or not all of the machine-learning algorithms identified in step 430 have been considered. If the service has not yet considered all of the machine-learning algorithms from step 430 (i.e., “Yes” in step 440), the service considers the next machine-learning algorithm. Otherwise if the service has considered all machine-learning algorithms from step 430 (i.e., “No” in step 440), the service returns to step 410.

In step 450, the service selects the best trialed model for the current machine-learning algorithm under consideration. Specifically, as mentioned above, each machine-learning algorithm is associated with a group of trialed models. Thus, the service may select the top-performing model or models within the trial group associated with the current machine-learning algorithm under consideration. The top-performing model(s) may be the model(s) associated with the minimum validation error, with the lowest validation errors (e.g., the top N lowest validation errors, where N is three, five, ten, etc.), and/or the like. Each top-performing model represents a region of local optima in the domain of hyperparameters, such that there is a high likelihood that the optimum set of hyperparameters is located within the region.

In an embodiment, in step 430, the service may sort all trials by the machine-learning algorithm and one or more other criteria. For example, the one or more other criteria may comprise a cross-validation or validation score associated with the trial. The service then ranks each machine-learning algorithm by the best trial (e.g., the trial with the highest cross-validation score) or trials (e.g., top two trials with the highest cross-validation scores) with which it is associated. Then, in step 450, the service may select the top N trials, where N is greater than or equal to one, such that each machine-learning algorithm is selected no more than K times, where K is also greater than or equal to one. The goal in step 430 is to select a small number of trials which perform well, but which are diverse in terms of the machine-learning algorithms that they use.

In step 460, the service executes a dedicated local search based on the model(s) selected in step 450. Specifically, a local search is executed within each region of local optima represented by the selected model(s). The local search may be performed by a derivative-free local optimization algorithm, such as Nelder-Mead, LIPO, Hill Climbing, Gradient Descent, and/or the like. The local search may use the hyperparameters of the starting model, selected in step 450, as a starting point. The local search over a given region of local optima, represented by the starting model, may produce a better model (i.e., a model with lower validation error) than that starting model. This improved model may then be used to generate new trials for the machine-learning algorithm (e.g., in step 420) and/or be otherwise utilized in subsequent steps (e.g., to be evaluated and displayed in steps 350 and 360 for possible selection and deployment in steps 370 and 380 in process 300).

It should be understood that one or more of the steps in process 400 may be executed in parallel. For example, step 440-460 may be executed in parallel for different machine-learning algorithms), such that local searches are performed on different machine-learning algorithms in parallel (e.g., using different worker threads to execute copies of a local search optimization service for different machine-learning algorithms). In addition, step 460 could be performed in parallel for different regions of local optima for the same machine-learning algorithm (e.g., again using different worker threads to execute copies of a local search optimization service for different regions). As another example, in step 420, Bayesian optimization may be performed for different machine-learning algorithms in parallel and/or trials for each machine-learning algorithm may be performed in parallel (e.g., again using different worker threads to execute copies of a Bayesian optimization service).

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive a plurality of machine-learning algorithms; and,
perform optimization by, for one or more iterations,
for each of the plurality of machine-learning algorithms, executing a Bayesian optimization algorithm to produce a plurality of trialed models, wherein each of the plurality of trialed models is associated with the machine-learning algorithm and a set of hyperparameters,
selecting a subset of best-performing ones of the plurality of machine-learning algorithms, and,
for each machine-learning algorithm in the subset of best-performing machine-learning algorithms,
selecting a best-performing model from the plurality of trialed models associated with the machine-learning algorithm, and
executing a local search algorithm starting from the set of hyperparameters associated with the selected best-performing model to identify an improved model that has better performance than the selected best-performing model.

2. The method of claim 1, wherein the local search algorithm comprises a derivative-free local optimization algorithm.

3. The method of claim 1, wherein the local search algorithm comprises a Nelder-Mead algorithm.

4. The method of claim 1, wherein the local search algorithm comprises a Lipschitz optimization (LIPO) algorithm.

5. The method of claim 1, wherein the local search algorithm comprises a hill-climbing algorithm.

6. The method of claim 1, wherein the local search algorithm comprises a gradient-descent algorithm.

7. The method of claim 1, wherein the subset of best-performing machine-learning algorithms are selected using cross-validation.

8. The method of claim 1, further comprising using the at least one hardware processor to:
evaluate a plurality of models resulting from the performed optimization;
generate a graphical user interface that comprises visual representations of the plurality of evaluated models in association with results of the evaluation; and,
in response to a selection of one of the plurality of evaluated models, deploy the model to a prediction service.

9. The method of claim 1, wherein the one or more iterations comprise a plurality of iterations, and wherein one or more new trials for the Bayesian optimization algorithm are generated based on one or more of the improved models.

10. The method of claim 1, wherein the subset of best-performing ones of the plurality of machine-learning algorithms comprises two or more machine-learning algorithms.

11. A system comprising:
at least one hardware processor; and
one or more software modules configured to, when executed by the at least one hardware processor,
receive a plurality of machine-learning algorithms, and,
perform optimization by, for one or more iterations,
for each of the plurality of machine-learning algorithms, executing a Bayesian optimization algorithm to produce a plurality of trialed models, wherein each of the plurality of trialed models is associated with the machine-learning algorithm and a set of hyperparameters,
selecting a subset of best-performing ones of the plurality of machine-learning algorithms, and,
for each machine-learning algorithm in the subset of best-performing machine-learning algorithms,
selecting a best-performing model from the plurality of trialed models associated with the machine-learning algorithm, and
executing a local search algorithm starting from the set of hyperparameters associated with the selected best-performing model to identify an improved model that has better performance than the selected best-performing model.

12. A non-transitory computer-readable medium having instructions stored therein, wherein the instructions, when executed by a processor, cause the processor to:
receive a plurality of machine-learning algorithms; and,
perform optimization by, for one or more iterations,
for each of the plurality of machine-learning algorithms, executing a Bayesian optimization algorithm to produce a plurality of trialed models, wherein each of the plurality of trialed models is associated with the machine-learning algorithm and a set of hyperparameters,
selecting a subset of best-performing ones of the plurality of machine-learning algorithms, and,
for each machine-learning algorithm in the subset of best-performing machine-learning algorithms,
selecting a best-performing model from the plurality of trialed models associated with the machine-learning algorithm, and
executing a local search algorithm starting from the set of hyperparameters associated with the selected best-performing model to identify an improved model that has better performance than the selected best-performing model.
